(19) United States
(12) Patent Application Publication
(10) Pub. No.: US 2003/0141154 A1
(43) Pub. Date: Jul. 31, 2003

(54) Rotor for disk brake assembly

(76) Inventors: Yvon Rancourt, Quebec (CA); Claude Rancourt, Quebec (CA)

Correspondence Address: BIRCH STEWART KOLASCH & BIRCH, PO BOX 747, FALLS CHURCH, VA, 22040-0747, US

(21) Appl. No.: 10/275,732

(22) PCT Filed: May 8, 2001
(86) PCT No.: PCT/CA01/00638

(30) Foreign Application Priority Data
May 8, 2000 (CA) 2307753

(51) Int. Cl. F16D 65/10

(52) U.S. Cl. 188/218 XL

(57) ABSTRACT

A disc brake assembly for a vehicle wheel wherein the wheel includes a hub journaled to an axle on the vehicle and a housing mounted to the vehicle, an annular rotor disc (10) within the housing and means mounting the rotor disc to the wheel which comprises an annular hub portion. The rotor disc (10) includes an annular peripheral portion (22) relative to an axial axis with an outer peripheral surface (20) and at least a first radial planar friction surface (12) on the annular peripheral portion (22). The rotor disc (10) has a plurality of circumferentially spaced-apart slots (26) extending axially through the peripheral portion (22) and inwardly towards the axial axis from the outer peripheral surface (20) thereof.

### TECHNICAL FIELD

The present invention relates to disc brakes and more particularly to improvements in large area contact disc brakes for vehicles.

### BACKGROUND ART

The concept of the full annular disc brake is proposed for automobiles and light trucks and the present invention relates to an improvement over the structure of a full annular disc brake for such vehicles as described in PCT published application WO98/29671 published Jul. 9, 1999 in the name of Yvon Rancourt. Disc brakes for full annular disc brakes for larger vehicles such as trucks are described in U.S. Pat. No. 5,330,034 issued on Jul. 19, 1994 and U.S. Pat. No. RE 35,055 issued on Oct. 10, 1995.

There are obvious advantages in having a complete annular array of friction pads contacting an annular disc on both sides of the disc. The braking or thermal energy distribution is related directly to the thermal resistance associated with both sides of the interface where the heat is generated. In a full annular brake there is a large area to distribute the braking energy more efficiently.

It has also been found that vibrations between the inner and outer pads are the major causes for brake squeal.

In a brake system, dynamic loading produces stresses and strains, the magnitude and distribution of which will depend not only on the usual parameters encountered previously but also on the velocity of propagation of the strain waves through the material of which the system is composed. This latter consideration, although very important when loads are applied with high velocities, may often be neglected when the velocity of application of the load is low. Since dynamic loading is conveniently considered to be the transfer of energy from one system to another, the concept of configuration (strain energy) as an index of resistance to failure is important. One of the important concepts is that the energy-absorbing capacity of a member, that is, the resistance to failure is a function of the volume of material available, in contrast to the resistance to failure under static loading, which is a function of cross-sectional area or section modulus.

One of the main problems in adapting the technology of a full annular brake system of the type described in the above-mentioned patents is the consideration of weight and cost. It would be unrealistic, no matter what the advantages, to assume that a new full annular brake system would be accepted on the market at a price substantially higher than present-day disc brakes. Furthermore any increase of weight compromises the fuel consumption.

The rotor disc has been contemplated as being a full disc with fin cooling as compared to the ventilated rotor disc described in WO98/29671. However there are concerns about thermal distortions in such a disc, especially in extreme braking conditions.

### DISCLOSURE OF THE INVENTION

It is an aim of the present invention to provide an improved rotor disc for a disc brake system especially for automobiles, that has improved heat distribution properties.

It is still a further aim of the present invention to provide an annular disc brake system where the maximum brake performance is obtained.

A construction in accordance with the present invention comprises a rotor disc for a disc brake assembly for a vehicle wheel wherein the wheel includes a hub journaled to an axle on the vehicle, the disc brake assembly comprises a housing mounted to the vehicle and at least an annular solid rotor disc within the housing and means mounting the rotor disc to the wheel which comprises an annular hub portion, the rotor disc including an annular peripheral portion relative to an axial axis with an outer peripheral surface and at least a first radial planar friction surface on the annular peripheral portion; the housing includes a first annular brake shoe provided adjacent the first planar friction surface of the disc and movable axially towards and away from the first friction surface; the improvement is characterized by the rotor having a plurality of circumferentially spaced-apart slots extending axially through the peripheral portion and inwardly towards the axial axis from the outer peripheral surface thereof.

In a more specific embodiment of the present invention the slots defined in the rotor disc each have a non-planar configuration and more specifically may be generated by a straight line parallel to the axial axis and defining a sine curve in the radial direction.

In a still more specific embodiment of the present invention, a damping element is provided in at least some of the slots formed in the peripheral portion of the rotor disc in order to reduce vibrations in the rotor disc during braking.

In a further specific embodiment of the present invention, the peripheral portion of the rotor disc is effectively separated into individual components by the slots and retention elements may be provided in the slots to restrain the individual components from axial displacement relative to other individual components and thus maintain the friction surface in a common radial plane.

### BRIEF DESCRIPTION OF THE DRAWINGS

The invention will now be described in detail having reference to the accompanying drawings in which:

FIG. 1 is perspective view of an embodiment of the rotor disc for a disc brake assembly in accordance with the present invention;

FIG. 2 is an enlarged fragmentary side elevation view of the rotor disc as shown in FIGS. 1;

FIG. 3 is an enlarged, exploded, fragmentary perspective view of another embodiment of the present invention;

FIG. 4 is a fragmentary side elevation of the embodiment shown in FIG. 3; and

FIG. 5 is an enlarged fragmentary side elevation, partly in cross-section showing the embodiment of FIG. 4 in an assembled condition.

### MODE FOR CARRYING OUT THE INVENTION

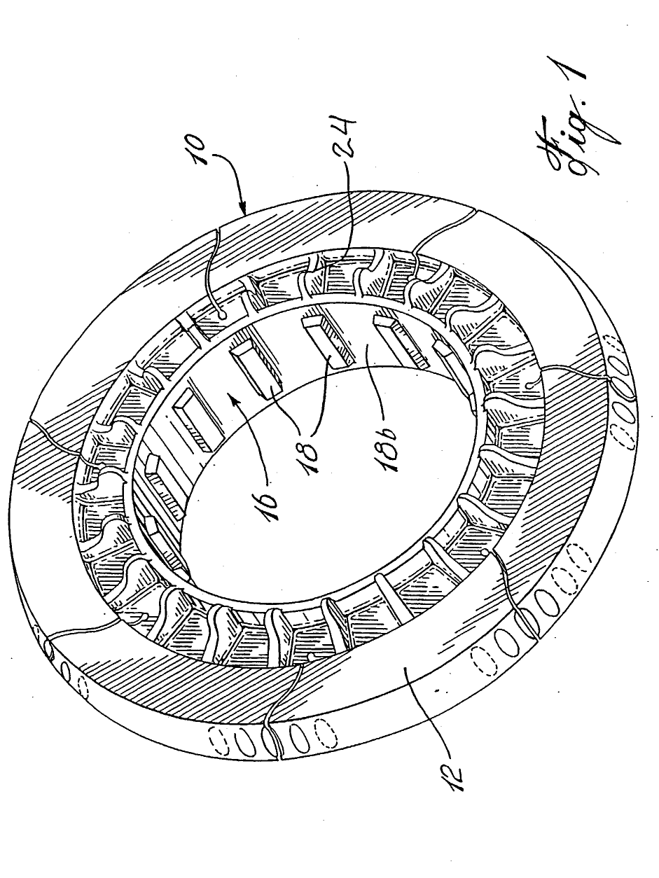

Referring now to the drawings there is shown an annular rotor disc 10 includes radial planar braking surfaces 12 and 14 and a cylindrical annular rim 16 having an inner concentric surface 18 with ribs 18a and valleys 18b. The rotor includes a peripheral annular member 22 which defines the planar braking surfaces 12 and 14. The outer peripheral surface 20 includes cooling ribs 20a which have been defined by machined valleys 20b. Cooling fins 24 are also provided between the annular member 22 and the rim 18. The cooling fins 24, as shown in FIG. 1 for instance, are spaced apart circumferentially and extend radially in axial planes.

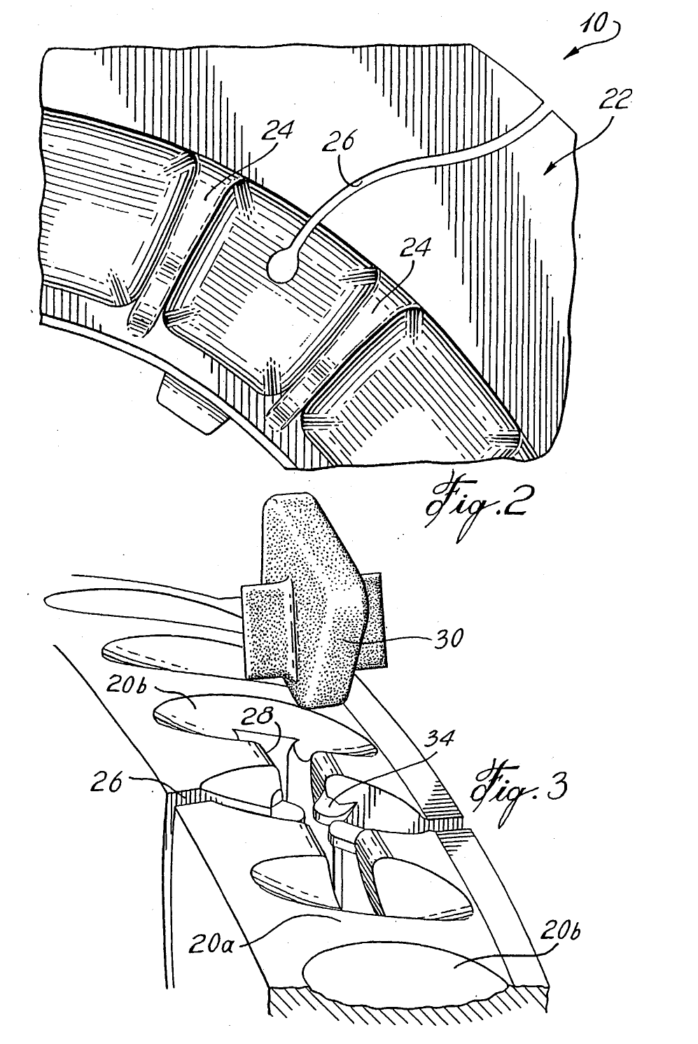

In order to eliminate the thermal stresses in the peripheral annular member 22 and the rotor in general, slots 26 have been provided to interrupt the continuity of the annular member 22. In the present embodiment, the slots 26 are configured along a sine curve, as seen in the side view of FIG. 2. The slots 26 extend generally in the radial direction and traverse the peripheral annular portion 22 in the axial direction from the braking surface 12 to the braking surface 14. Each slot 26 also opens to the peripheral outer surface 20.

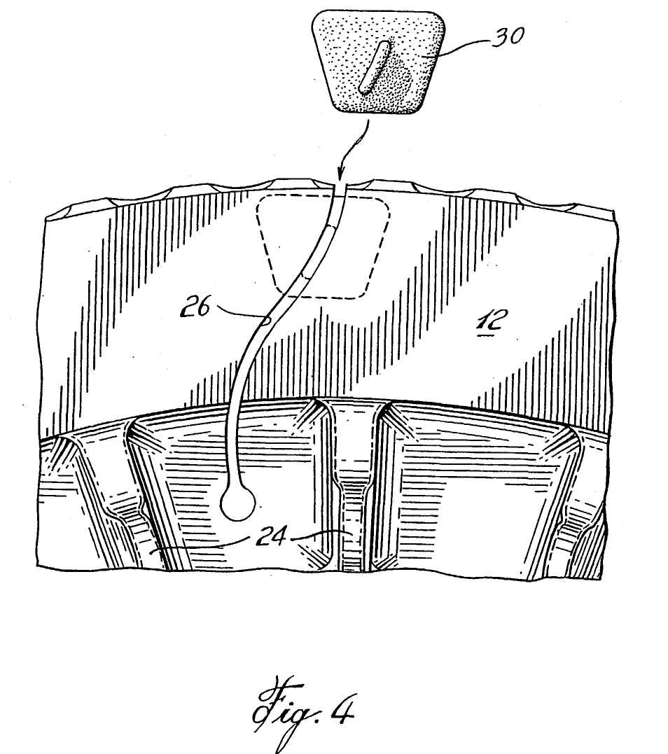

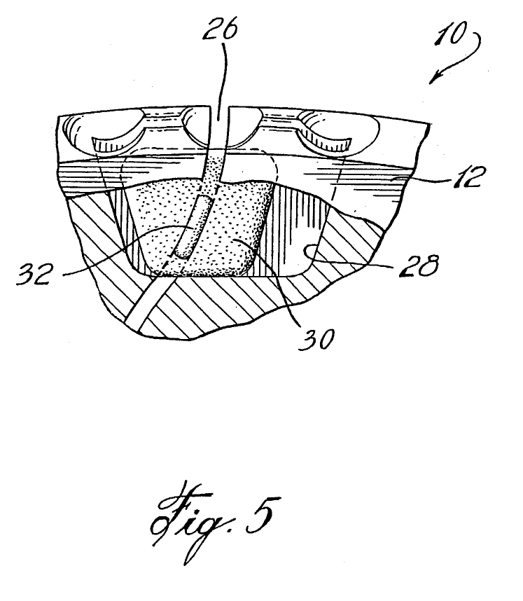

In the embodiment of the invention shown in FIGS. 3 and 4, a slot 28 is provided from the outer peripheral surface 20 and extends a short distance in the circumferential direction. The slot 28 intersects the slot 26 and the two slots form a cruciform.

An insert 30 having a thickness approximately the width of slot 28 is then inserted in slot 28 from the outer peripheral surface 20. The insert 30 may be a flat plate-like member with wings 32 that are shaped to fit into slots 26 on either side thereof. The insert 30 may be covered with an elastomeric material. The elastomeric material could be a silicone rubber composition covering a metal substrate.

The purpose of insert 30 is to provide a damping device effective to reduce any vibration in the rotor disc 10, particularly with the application of the brake shoes on either side of the braking surfaces 12 and 14. The insert 30 also locks the adjacent segments of the annular portion 22 defined by the slots 26 in order to restrain the segments from axial distortions relative to each other and therefore misaligning the respective braking surfaces 12 and 14 from the braking plane defined by these braking surfaces. As shown in FIG. 3, tabs may be formed at the outer peripheral surface 20 which extend over slots 26 and 28 in order to lock the insert 30 within the slots.

The slots 26 will also act to eliminate gases which form between the friction pads of the brake shoes and the braking surfaces 12 and 14 on the rotor disc. The circumferential spacing of the slots 26 must be out of phase with the spacing of the array of friction pads on the brake shoe. Typically, a rotor disc would have between five and nine slots and preferably seven slots.

It is understood that other forms of inserts might be utilized depending on whether the aim is to reduce vibrations or prevent misalignment of the annular portion segments or both. It is also clear that the configuration of slot 26 can vary but it is believed to be important that the slot extend axially through the annular portion, that is from the braking surface 12 to the braking surface 14 and to the peripheral outer surface 20.

1. In a disc brake assembly for a vehicle wheel wherein the wheel includes a hub journaled to an axle on the vehicle and a housing mounted to the vehicle, an annular rotor disc within the housing and means mounting the rotor disc to the wheel which comprises an annular hub portion, the rotor disc including an annular peripheral portion relative to an axial axis with an outer peripheral surface and at least a first radial planar friction surface on the annular peripheral portion; characterized in that the rotor has a plurality of circumferentially spaced-apart slots extending axially through the peripheral portion and inwardly towards the axial axis from the outer peripheral surface thereof.

2. The rotor disc as defined in claim 1 wherein the slots defined in the rotor disc each have a non-planar configuration.

3. The rotor disc as defined in claim 2 wherein each slot defines a sine curve in the radial direction.

4. The rotor disc as defined in claim 1 wherein a damping element is provided in at least some of the slots formed in the peripheral portion of the rotor disc in order to reduce vibrations in the rotor disc during braking.

5. The rotor disc as defined in claim 1 or 3 wherein the peripheral portion of the rotor disc is effectively separated into individual components by the slots and retention elements may be provided in the slots to restrain the individual components from axial displacement relative to other individual components and thus maintain the friction surface in a common radial plane.

6. The rotor disc as defined in claim 1 wherein each slot is intersected by a circumferentially extending slot forming a cruciform therewith and an insert comprising a cruciform element is inserted into the intersecting slots in order to dampen the vibrations in the rotor during a braking operation and the peripheral portion of the rotor disc is effectively separated into individual components by the slots whereby the insert acts as a restraining element in the intersecting slots to restrain the individual components from axial displacement relative to other individual components and thus maintain the friction surface in a common radial plane.

7. The rotor disc as defined in claim 6 wherein the insert is an elastomeric core covered by a metal jacket.
